(19) United States
(12) Patent Application Publication
(10) Pub. No.: US 2026/0109476 A1
(43) Pub. Date: Apr. 23, 2026

(54) FOLDABLE AND TRANSPORTABLE LANDING PADS AND METHODS OF DEPLOYMENT THEREOF

(71) Applicant: Cherokee Nation Aerospace and Defense, L.L.C., Tulsa, OK (US)

(72) Inventors: Justin Vandy, Tulsa, OK (US); Chris Moody, Tulsa, OK (US)

(21) Appl. No.: 19/362,382

(22) Filed: Oct. 18, 2025

Related U.S. Application Data
(60) Provisional application No. 63/709,230, filed on Oct. 18, 2024.

(51) Int. Cl. B64F 1/00; B60P 3/00

(52) U.S. Cl. CPC B64F 1/007; B60P 3/00

(57) ABSTRACT

Examples of deployable, collapsible, and transportable landing pads are provided herein. An example landing pad includes a first panel extending in a first direction, the first panel having a plurality of hinge openings along two opposing side edges along the first direction; a second panel hinged to the first panel at hinge openings of a first of the two opposing side edges; and a third panel hinged to the first panel at hinge openings of a second of the two opposing side edges, the second panel and the third panel foldable toward each other during transportation and deployable to provide a flat top surface together with the first panel during use as a helipad. In some cases, the first panel is secured onto a mobile platform for ground transportation. In some cases, additional panels may be assembled with the landing pad to increase the overall landing area.

### TECHNICAL FIELD

The present disclosure relates to landing pads and methods of the deployment of the landing pads.

### BACKGROUND

Helicopters (either manned or unmanned) and other vertical take-off and landing (VTOL) aircrafts benefit from landing on helipads for safety and convenience, because helipads provide a stable, flat, and well-marked surface away from obstacles. Helipads are important infrastructure for aviation and support various sectors, including emergency response, medical services, and other time-sensitive transportations.

Helipads often include safe and stable platforms, such as on the ground or on roof tops, for helicopters to land and take off. There are structural and visual safety features and often provide guard rails and a non-slippery surface for avoiding accidents. Helipads may therefore enable prompt and efficient operations. For example, the marking on helipads allows for accurate determination of the distance between the vehicle and the landing surface. Most helipads are permanent and therefore immobile.

### SUMMARY

The present disclosure provides examples of collapsible (e.g., foldable, re-configurable, or modular) and transportable landing pads that offer benefits of conventional helipads while improving location flexibility and operational efficiency. For example, an example landing pad may be transported in a folded or modular configuration, either on ground or in air and deployed at target locations.

For foldable landing pads, when transported on ground, the landing pad is folded within a width of traffic lane (e.g., 10-12 ft, or 3.7 m). Some embodiments of the landing pad include wheels and are towable to be deployed at desired locations. When transported in air, the folded landing pad may be lifted in open air or fitted inside a transporter aircraft (e.g., a C-130). Depending on the number of fold lines (e.g., two or more), the foldable landing pad may thus have different deployment dimensions to accommodate landing for different VTOL aircrafts.

For modular landing pads, pieces of deck modules are stowed or packaged for transportation. The modular landing pads are subject to less size constraints than the foldable landing pads because the deck modules may be separately transported using multiple and/or different transports.

In a first general aspect, a landing pad includes a first panel extending in a first direction, the first panel having a plurality of hinge openings along two opposing side edges along the first direction; a second panel hinged to the first panel at hinge openings of a first of the two opposing side edges; and a third panel hinged to the first panel at hinge openings of a second of the two opposing side edges, the second panel and the third panel foldable toward each other during transportation and deployable to provide a flat top surface together with the first panel during use as a helipad.

In some embodiments, the landing pad further includes a plurality of rollers or wheels mounted to and rotatable under the first panel; a plurality of trailer stabilizers; a trailer tongue coupler at a front end of the first panel; and a trailer tongue jack.

In some cases, the plurality of trailer stabilizers is distributed under the first panel, the second panel, and the third panel, and the plurality of trailer stabilizers, when deployed, levels the landing pad on a slope.

In some embodiments, the second panel and the third panel respectively include: a foldable staircase; a plurality of storage units underneath the first panel; and one or more hydraulic cylinders hinged on the first panel and configured to respectively power the second panel and the third panel to move between a folded position and a deployed position.

In some embodiments, the second panel includes a locking mechanism, and the third panel includes a corresponding opening to receive a hook of the locking mechanism to secure the second panel and the third panel in a folded position for transport or securing for storage.

In some cases, the locking mechanism further includes: an actuator configured to actuate a linkage causing the hook to engage the corresponding opening of the third panel; and a switch controlling the actuator. The switch may include a manual lever mechanically linked to the actuator, wherein the manual lever is movable between an open position and a closed position, and wherein the manual lever is lockable at the open position and the closed position.

In some embodiments, the first panel has a width no greater than a traffic lane width, and wherein the first panel, the second panel, and the third panel provide a plurality of light-emitting optical aids for identifying the landing pad.

In some embodiments, the landing pad further includes a fourth panel hinged at an outer edge of the second panel; and a fifth panel hinged at an outer edge of the third panel, wherein the fourth panel is foldable toward the second panel during transportation and deployable to align with the top surface for use as the helipad, and wherein the fifth panel is foldable toward the third panel during transportation and deployable to align with the top surface for use as the helipad.

In some cases, the fourth panel and the fifth panel respectively include a lock-in mechanism that biases respective hinge connections between the fourth panel and the second panel, and the fifth panel and the third panel, to stay aligned with the top surface.

In another general aspect, a mobile landing assistance system includes: a vehicle providing mobility; and a landing pad securable to the vehicle for transportation. The landing pad includes: a first panel extending in a first direction, the first panel having a plurality of hinge openings along two opposing side edges along the first direction; a second panel hinged to the first panel at hinge openings of a first of the two opposing side edges; and a third panel hinged to the first panel at hinge openings of a second of the two opposing side edges, the second panel and the third panel foldable toward each other during transportation and deployable to provide a flat top surface together with the first panel during use as a helipad.

In some embodiments, the landing pad further includes: a plurality of rollers or wheels mounted to and rotatable under the first panel; a plurality of trailer stabilizers; a trailer tongue coupler at a front end of the first panel; and a trailer tongue jack. In some cases, instead of wheels, a skid rail or a static base may be used to achieve a lower deck height. For example, the skid rail may be transported by a rolling trailer, and a static base may be transported using a shipping crate.

In some cases, the plurality of trailer stabilizers is distributed under the first panel, the second panel, and the third panel, and the plurality of trailer stabilizers, when deployed, levels the landing pad on a slope.

In some embodiments, the second panel and the third panel respectively include: a foldable staircase, ramp or lift; a plurality of storage units underneath the first panel; and one or more hydraulic cylinders hinged on the first panel and configured to respectively power the second panel and the third panel to move between a folded position and a deployed position.

In some embodiments, the second panel includes a locking mechanism, and the third panel includes a corresponding opening to receive a hook of the locking mechanism to secure the second panel and the third panel in a folded position.

In some cases, the locking mechanism further includes: an actuator configured to actuate a linkage causing the hook to engage the corresponding opening of the third panel; and a switch controlling the actuator. The switch includes a manual lever mechanically linked to the actuator, wherein the manual lever is movable between an open position and a closed position, and wherein the manual lever is lockable at the open position and the closed position.

In some embodiments, the landing pad further includes: a fourth panel hinged at an outer edge of the second panel; and a fifth panel hinged at an outer edge of the third panel, wherein the fourth panel is foldable toward the second panel during transportation and deployable to align with the top surface for use as the helipad, and wherein the fifth panel is foldable toward the third panel during transportation and deployable to align with the top surface for use as the helipad, wherein the fourth panel and the fifth panel respectively includes a lock-in mechanism that biases respective hinge connections between the fourth panel and the second panel, and the fifth panel and the third panel, to stay aligned with the top surface.

In some embodiments, the vehicle includes at least one of: a land vehicle configured to tow the landing pad during transportation; an ariel vehicle configured to lift the landing pad open in air during transportation; or an ariel vehicle configured to enclose and carry the landing pad during transportation.

In yet another general aspect, a method of transporting and deploying a landing pad includes positioning the landing pad in a folded condition at a target location. The landing pad includes a first panel extending in a first direction, the first panel having a plurality of hinge openings along two opposing side edges along the first direction; a second panel hinged to the first panel at hinge openings of a first of the two opposing side edges; and a third panel hinged to the first panel at hinge openings of a second of the two opposing side edges, and wherein the third panel is locked to the second panel using a locking mechanism in the folded condition. The method further includes releasing the locking mechanism to allow the second panel and the third panel freely rotate relative to the first panel. The method further includes positioning the second panel and the third panel to form a common flat surface with the first panel, the common flat surface being a helipad.

Various examples are described in detail below.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates a perspective view of a deployed transportable landing pad, in accordance with aspects of the present disclosure.

FIG. 2 illustrates a top view of the deployed transportable landing pad, in accordance with aspects of the present disclosure.

FIG. 3 illustrates a front view of the deployed transportable landing pad, in accordance with aspects of the present disclosure.

FIG. 4 illustrates a side view of the deployed transportable landing pad, in accordance with aspects of the present disclosure.

FIG. 5 illustrates a perspective view of a folded (or stowed) transportable landing pad, in accordance with aspects of the present disclosure.

FIG. 6 illustrates a perspective view of a frame for a first panel of the transportable landing pad of FIG. 1, in accordance with aspects of the present disclosure.

FIG. 7 illustrates a front view of the folded transportable landing pad, in accordance with aspects of the present disclosure.

FIG. 8 illustrates a side view of the folded transportable landing pad, in accordance with aspects of the present disclosure.

FIG. 9 illustrates a local view of a hydraulic cylinder (or an extender) configured to convert the landing pad between a folded position and a deployed position, and a handle or switch for locking the landing pad in the folded position, in accordance with aspects of the present disclosure.

FIGS. 10A and 10B illustrate detailed views of the hinge of panels of the landing pad between deployed and folded positions, in accordance with aspects of the present disclosure.

FIGS. 11A, 11B, and 11C illustrate detailed views of a latching or locking mechanism for securing the landing pad into the folded position during transportation, in accordance with aspects of the present disclosure.

FIG. 12 illustrates a detailed view of the handle or switch for actuating the latching or locking mechanism, in accordance with aspects of the present disclosure.

FIG. 13 illustrates a ground mobile landing assistance system including the landing pad in the folded position, in accordance with aspects of the present disclosure.

FIG. 14 illustrates the ground mobile landing assistance system including the landing pad in the deployed position, in accordance with aspects of the present disclosure.

FIG. 15 illustrates an air mobile landing assistance system including the landing pad in the folded position, in accordance with aspects of the present disclosure.

FIG. 16 illustrates an example of a relatively small VTOL aircraft, in accordance with aspects of the present disclosure.

FIG. 17 illustrates an example of a relatively large VTOL aircraft landed on a second mobile landing assistance system, in accordance with aspects of the present disclosure.

FIG. 18 illustrates the second mobile landing assistance system of FIG. 17 in the folded position, including the landing pad and carrying aircraft, in accordance with aspects of the present disclosure.

FIG. 19 illustrates a third mobile landing assistance system in a deployed configuration, in accordance with aspects of the present disclosure.

FIG. 20 illustrates the third mobile landing assistance system in a transportation configuration, in accordance with aspects of the present disclosure.

FIG. 21 illustrates a fourth mobile landing assistance system in a deployed and assembled configuration, in accordance with aspects of the present disclosure.

FIG. 22 illustrates a local perspective and transparent view of the fourth mobile landing assistance system, in accordance with aspects of the present disclosure.

FIG. 23 illustrates a partial top view and partial cross-section side view of the fourth mobile landing assistance system, in accordance with aspects of the present disclosure.

FIG. 24 illustrates a detailed local view of the partial cross-section side view of the fourth mobile landing assistance system, in accordance with aspects of the present disclosure.

FIG. 25 illustrates multiple different views of a connector piece of the four mobile landing assistance system, in accordance with aspects of the present disclosure.

FIG. 26 illustrates a flow chart of the process of deploying a landing pad, in accordance with aspects of the present disclosure.

Like numerals indicate like elements.

### DETAILED DESCRIPTION

Examples of deployable, foldable/collapsible, and transportable landing pads are disclosed herein. The disclosed various examples of landing pads provide stable and level platforms that are rapidly deployable and convenient for transportation. The example landing pads include various sizes and use corresponding transportation means for suitable situations. For example, a mobile vertical helipad (vertipad) platform (MVP) integrates a single trailer and is sized, when in folded configuration, for legal highway transportation. A second example of the landing pads may utilize sizes allowed by cargo aircrafts and is deployable utilizing the impact of the landing. A third example of the landing pads utilizes two or more trailers and is configured to be assembled to achieve a larger landing area. A fourth example of the landing pads uses multiple panels for assembly at a target area, without constraints of the landing area. In these example landing pads, visible and/or infrared lighting are provided for tactical autonomous operations. Some examples of the landing pad system may be transported via sling load for tactical deployment, or by truck with the standard towing ball or pintle interface.

This disclosure provides various examples of the collapsible and transportable landing pad systems that provide avionics to assist vertical take-off and landing (VTOL) flight operations. For example, the onboard avionics may include but not be limited to Ground Based Augmentation System, MICRO Ground Based Augmentation System (M-GBAS) Landing System and a Ground Meteorological Augmentation System (GMAS). The combination of systems does not exist in current market offerings and may provide unparalleled autonomy for manned and unmanned systems. The example systems are based on the Air Mobility (AM) ecosystem for developing and implementing an automated integration with air traffic control, aircraft, ground, and space-based navigation systems.

The present disclosure provides example systems for an autonomous Landing Pad System for VTOL vehicles enabling Point in Space (PinS) operations within the National Airspace System (NAS). As such, the disclosed example systems may support Advanced Air Mobility (AAM), which includes supporting manned aircraft in a structured airspace architecture as well as implementation of On Demand Mobility (ODM).

The present disclosure provides different examples of collapsible and transportable landing pads improving urban air mobility (UAM) operations. Examples of the landing pads improve the safe operation, scalability, and efficiency for transporting and deploying landing pads for UAM operations. During operation, the deployed landing pads improve functions of autonomous functions of the UAM operations. For example, the disclosed autonomous landing pad system may provide a safe landing platform for various aircrafts to launch, as well as to recover from.

According to the definitions by the American Society for Testing and Materials (ASTM International), landing surfaces are characterized into three types or categories: the Vertiport, the Vertipad, and the Vertistop. The Vertiport is for Short Take-Off and Landing (STOL) operations with services, fuel, and rest areas. The Vertipad is similar to “helipad” and for UAM operations. The Vertistop is a landing surface with no fueling, de-fueling, maintenance or services. Establishing multiple landing surfaces such a Vertipad or Vertiports require permanent structures or services such as surveying, altering the landing area, dropping concrete, and providing a power source for lighting may be too costly for rapid deployment. Examples of this disclosure improve scalability of the transportable Vertistop that may enable maximum flexibility to dispatch operators. The collapsibility or foldable configuration in the disclosed examples is also adaptable to the ever-changing needs of the local communities while achieving similar or comparable precision of a permanent surveyed landing surface.

Examples of this disclosure provides various configurations of deployable landing pad systems that maintain precision operations and are independent of the type of vehicles being flown (e.g., unmanned and manned VTOL aircrafts). The associated form of autonomy meets or exceeds current day Instrument Flight Rule (IFR) verification and validation of procedures and landing surfaces. Validation of the deployed landing pads may provide a similar or comparable level of accuracy when vertical guidance is given to airports with ground based or space-based guidance systems. For example, a precision approach may be achieved with an accurate field elevation reporting system, a High Precision Latitude and Longitude (HP LAT/LONG), and weather reporting capability at the surface.

Aspects of this disclosure include using solar panel technology, shore power, solar panel technologies, portable power generators, and battery storage to power various subsystems in the example landing pads, including navigation, weather reporting, lighting systems, and other subsystems. For example, the landing surface may include a clear laminate with solar cell containing light emitting diodes (LED's) and electrical circuits embedded within to produce electricity.

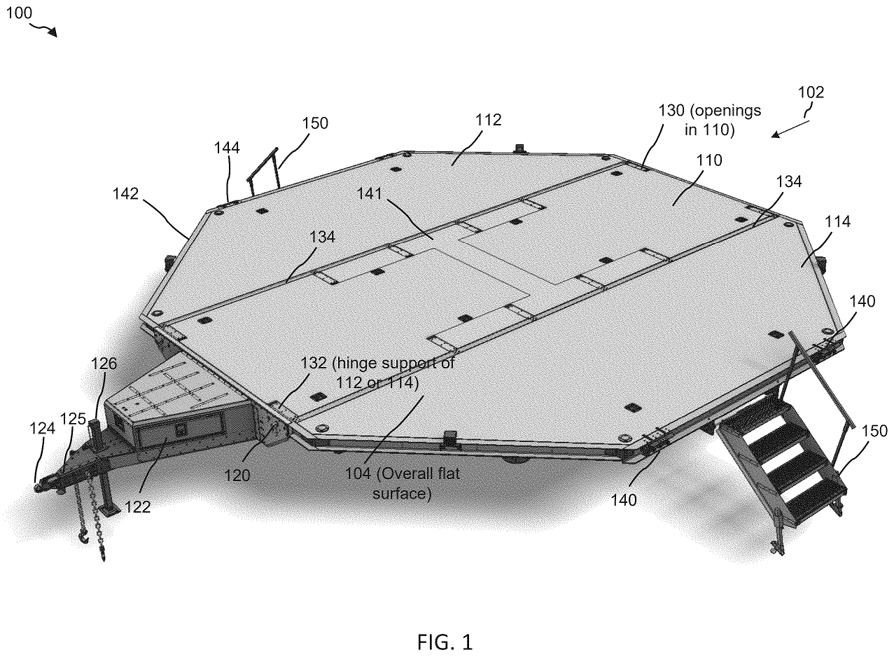

FIG. 1 illustrates a perspective view of a first example of a collapsible and transportable landing pad 100, in accordance with aspects of the present disclosure. As shown, the collapsible landing pad 100 includes a first panel 110 extending in a first (longitudinal) direction 102. The first panel 110 includes multiple hinge openings 130 along two opposing side edges 134 along the first direction 102. The landing pad 100 further includes a second panel 112 hinged to the first panel 110 at hinge openings 130 of a first of the two opposing side edges 134. The landing pad 100 further includes a third panel 114 hinged to the first panel 110 at hinge openings 130 of a second of the two opposing side edges 134. In the deployment configuration shown in FIG. 1, the first panel 110, the second panel 112, and the third panel 114 form a flat top surface 104 for use as a helipad. In a transportation configuration, the second panel 112 and the third panel 114 may be folded and secured toward each other (as shown in FIGS. 13-15 and 18).

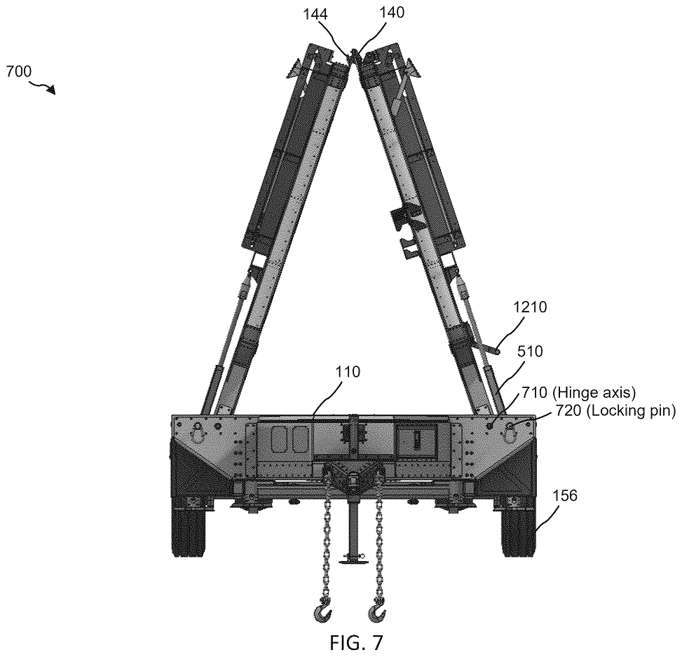

In the deployed configuration, the second panel 112 and the third panel 114 may be locked into the deployed position with respect to the first panel 110 using the pins 120 shown in FIG. 1 or 720 shown in FIG. 7. The locking pin 120 or 720 may be adjacent to the hinge axis 710, about which the respective outer panels 112 or 114. The second panel 112 and the third panel 114 respectively include multiple high supports 132 to be hinged at the openings 130.

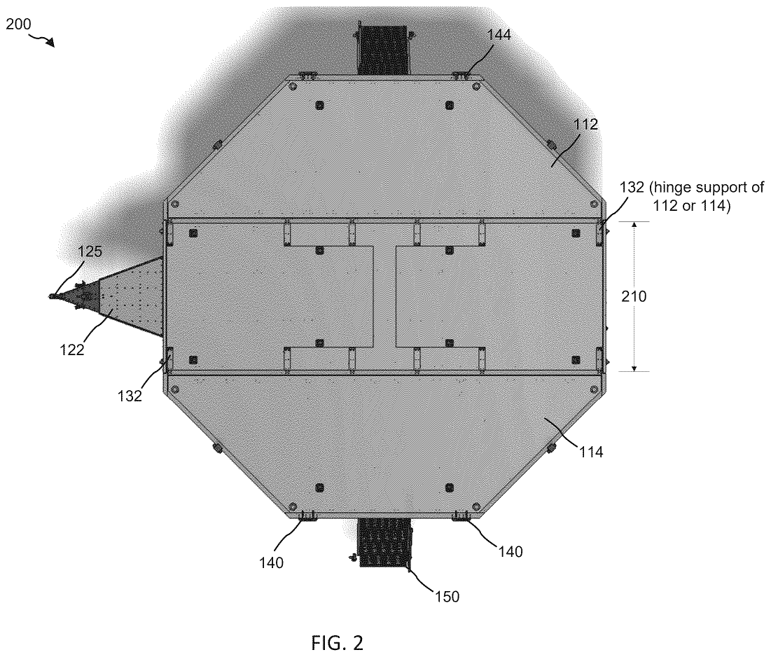

FIG. 2 illustrates a top view 200 of the deployed landing pad 100, in accordance with aspects of the present disclosure. As shown in the top view 200 along with the perspective view of FIG. 1, the deployed landing pad 100 includes central markings 141 (e.g., “H”) and perimeter markings 142 to be identified as a helipad. The central markings 141 and the perimeter markings 142 may include reflective lighting (e.g., using reflective surface coating or stickers) and emissive lighting (e.g., using light sources, such as light emitting diodes (LEDs) powered by the landing pad 100).

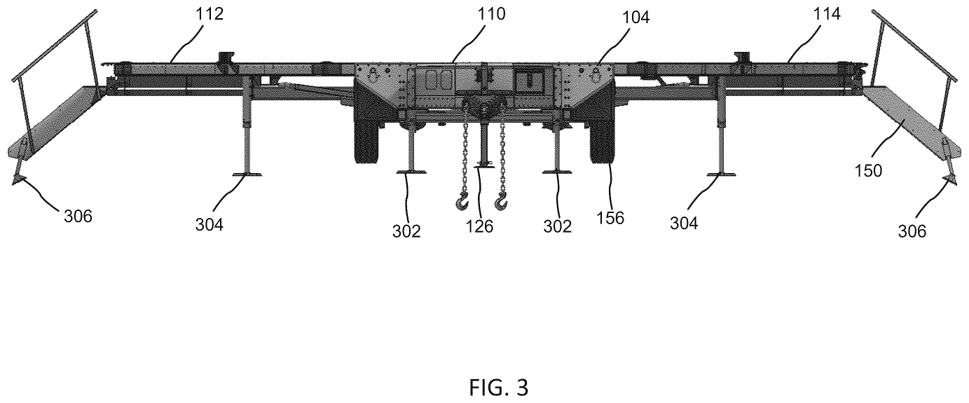

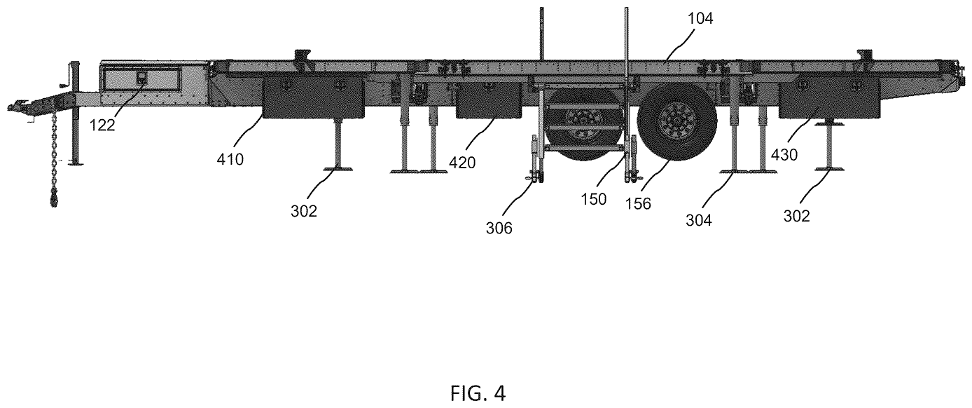

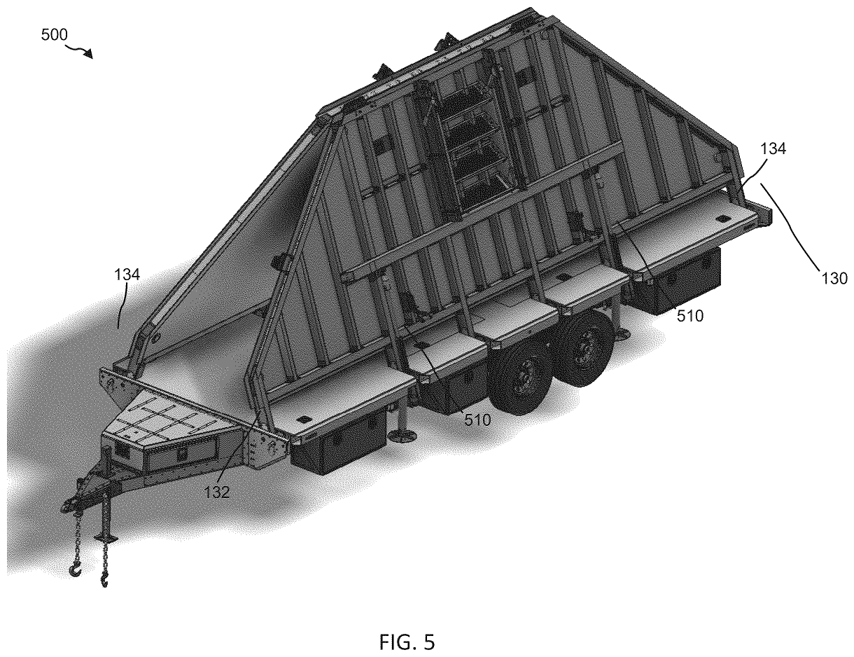

FIG. 3 illustrates a front view of the deployed transportable landing pad. FIG. 4 illustrates a side view of the deployed transportable landing pad. FIG. 5 illustrates a perspective view 500 of a folded (or stowed) transportable landing pad. As shown in FIGS. 3-5, the landing pad 100 further includes a plurality of rollers or wheels 156 mounted to and rotatable under the first panel 110. The landing pad 100 may further include a plurality of trailer stabilizers 302, 304, and 306. The landing pad 100 may also include a trailer tongue 124 coupler at a front end 125 of the first panel; and a trailer tongue jack 126. In some cases, the trailer tongue 124 may be in the form of a ring (e.g., hitch Lunette ring) or a hook (e.g., a Pintle hook hitch) instead of a spherical receptacle. The plurality of trailer stabilizers 302, 304, and 306 are distributed under the first panel 110, the second panel 112, and the third panel 114. The plurality of trailer stabilizers 302, 304, and 306, when deployed, may level the landing pad 100 on a slope. Some of the trailer stabilizers 302, 304, and 306 may be extended sideways (e.g., in a direction perpendicular to the first direction 102) to respectively support the second panel 112 and the third panel 114 in the deployed position.

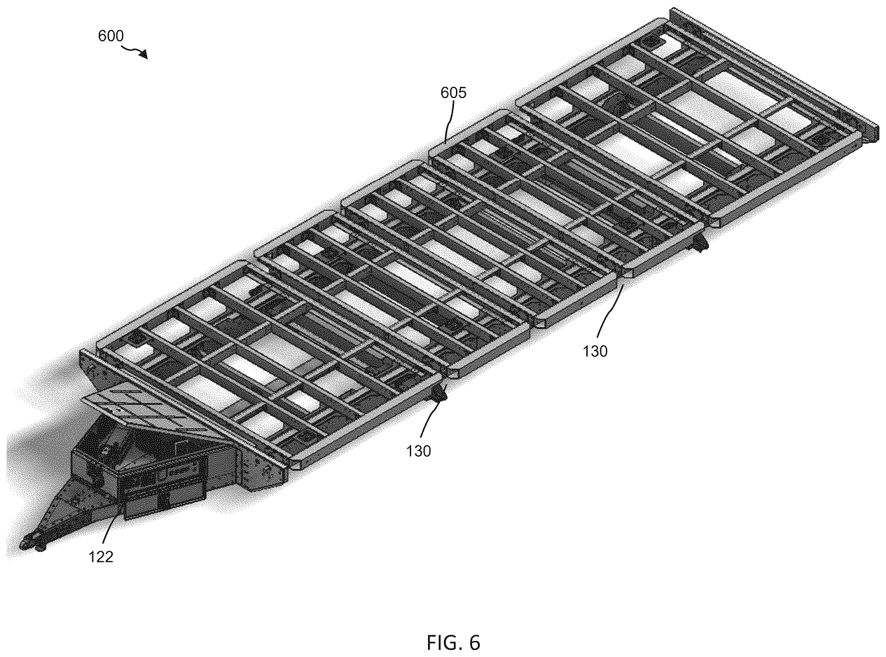

FIG. 6 illustrates a perspective view of a frame 600 for the first panel 110 of the transportable landing pad 100 of FIG. 1. As shown, the frame 600 includes a flat, rectangular lattice made from metal members with hollow box sections, arranged in an orthogonal grid at spacing as shown. The frame 600 may include multiple pre-fabricated rectangular modules separated at the hinge openings 130. Each of the rectangular modules secured or affixed onto longitudinal beam members by welding, riveting, or other fastening means.

The first panel 110 is supported by the frame 600, which provides strength and integrity for the landing pad 100. The control compartment 122 of the frame 600 may include a control panel, storage space for electronic equipment (e.g., controller and processing devices), and power supply. The controller may control the overall operations of the landing pad 100, such as changing between the deployed position and the folded/stowed position, operating signals or lighting devices, and deploying and retracting the stabilizers 3020-306. The frame 600 provides a flat top surface 605 on which additional layers of materials are added to form the landing surface 104.

In some embodiments, the second panel 112 and the third panel 114 respectively include: a foldable staircase 150, a plurality of storage units 410, 420, and 430 underneath the first panel 110; and one or more hydraulic cylinders 510 hinged on the first panel 110 and configured to respectively actuate, by extension or contraction, the second panel 112 and the third panel 114 to move between a folded configuration (as shown in the perspective view 500 of FIG. 5) and a deployed configuration (as shown in the top view 200 of FIG. 2). The hydraulic cylinders 510 may be electrically powered and controlled by a controller located in the control compartment 122.

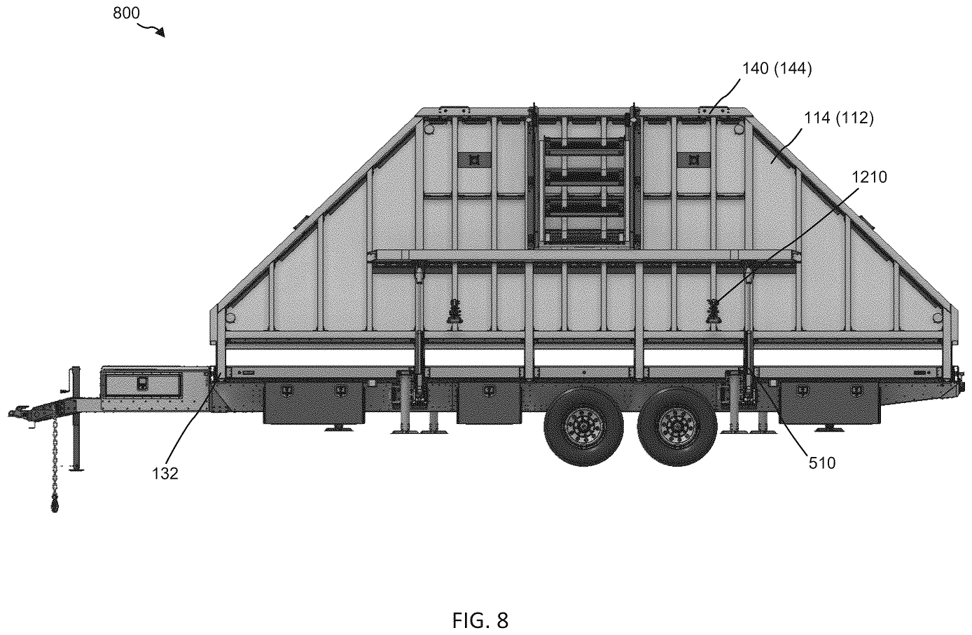

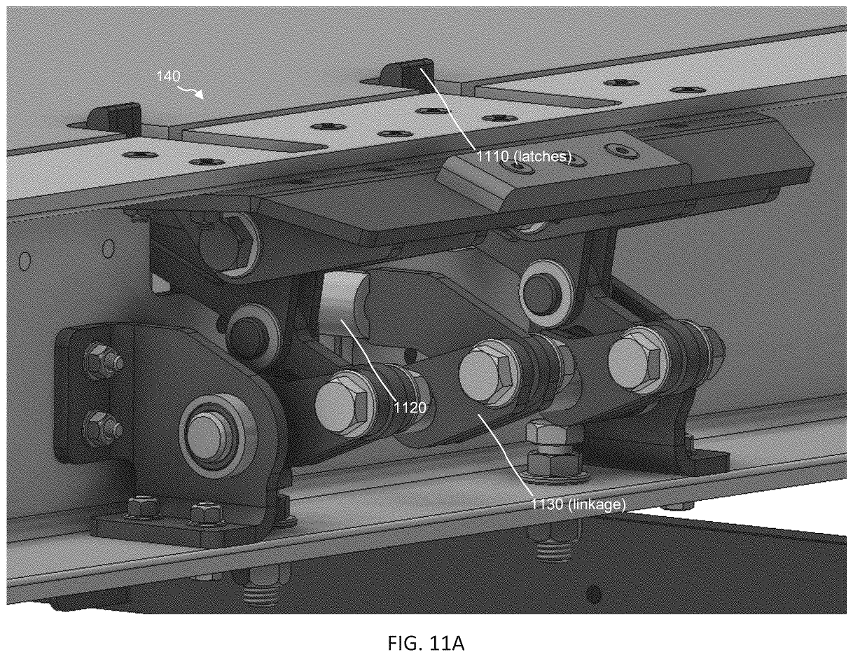

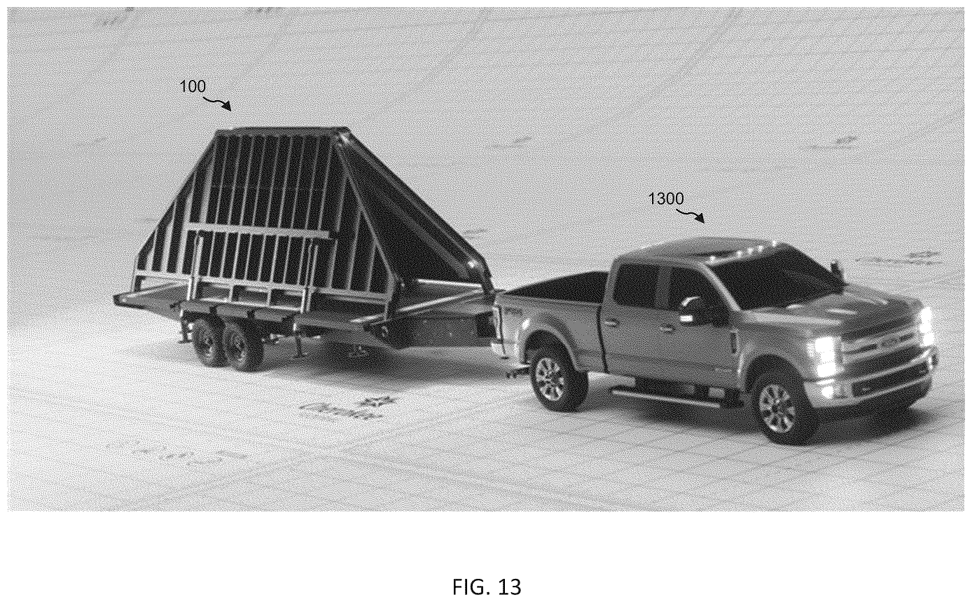

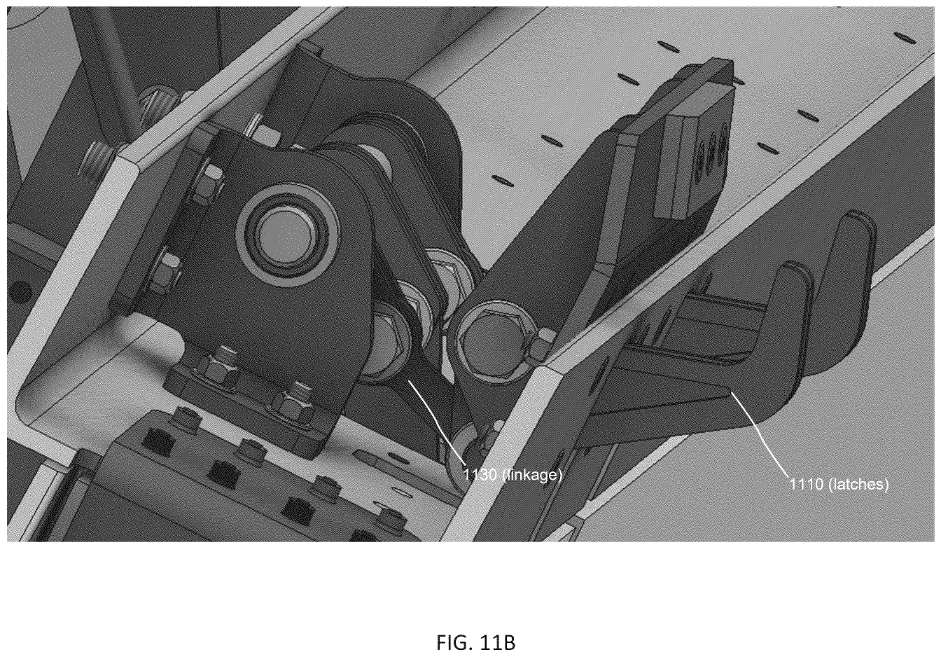

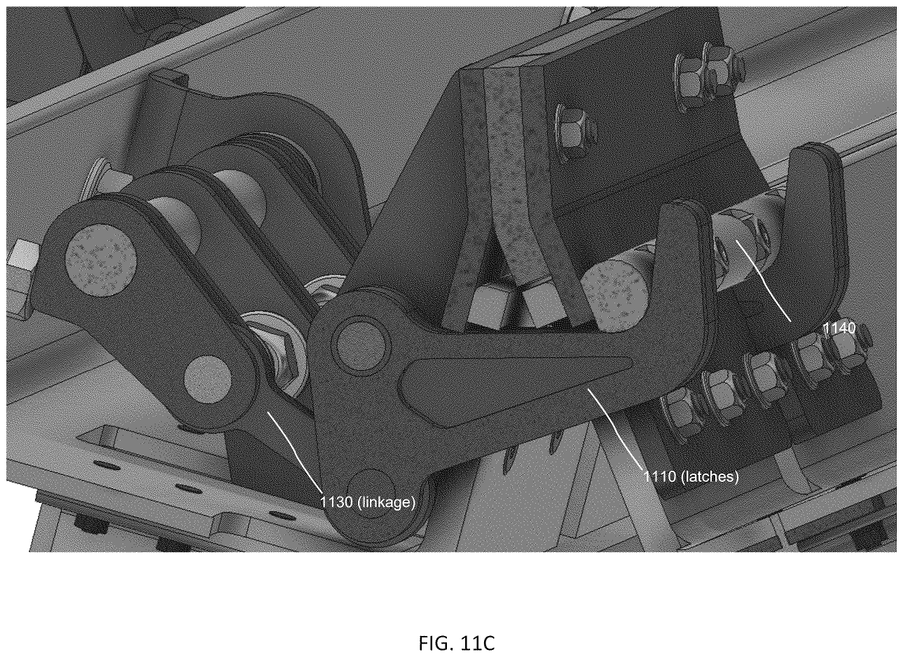

FIG. 7 illustrates a front view 700 of the folded transportable landing pad 100. As shown, when the hydraulic cylinders 510 are fully extended, the second panel 112 and the third panel 114 meet with each other at the top and are locked in place via a locking mechanism 140. Details of the locking mechanism 140 are further illustrated in FIGS. 11A, 11B, and 11C, which provide detail views of the latching or locking mechanism 140 for securing the landing pad into the folded position/configuration during transportation. FIG. 8 illustrates a side view 800 of the folded transportable landing pad, showing the longitudinal positions of two locking mechanisms 140.

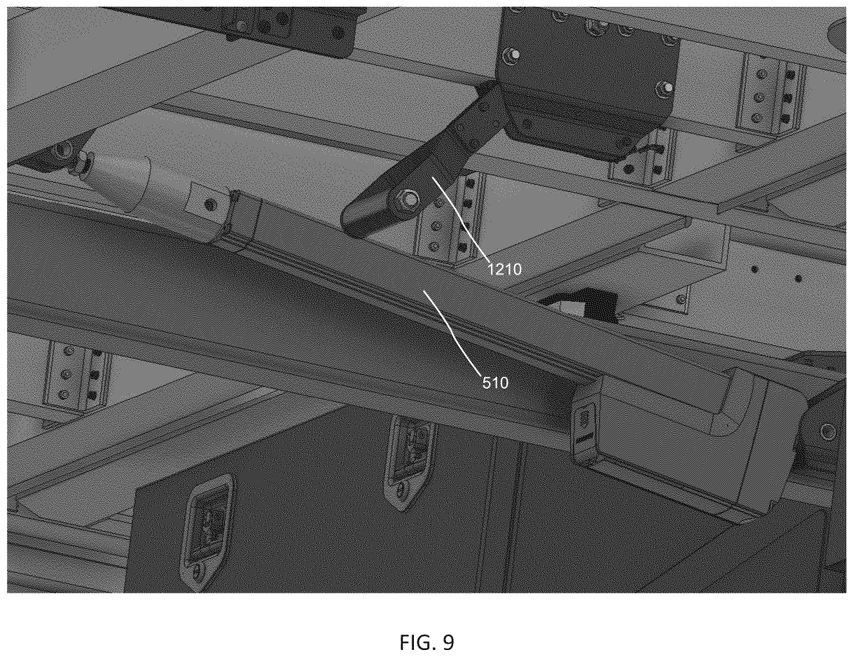

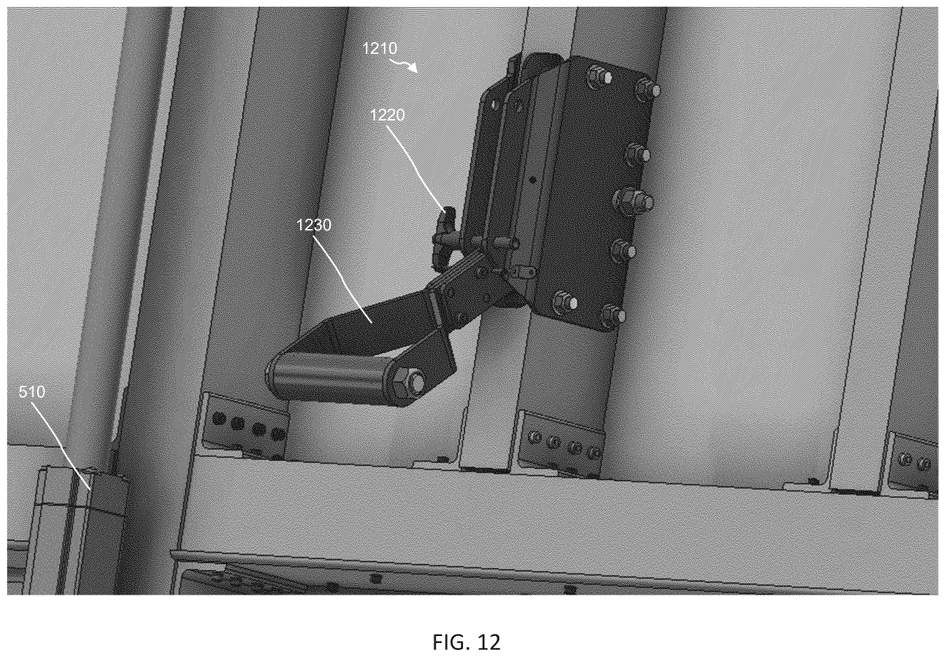

FIG. 9 illustrates a local view of the hydraulic cylinder (or an extender) 510 configured to convert the landing pad between a folded position (shown in FIGS. 5, 7-8, 13, and 15) and a deployed position (shown in FIGS. 1-4, 14, and 16), and a handle or switch 1210 for locking the landing pad 100 in the folded position. Details of the handle 1210 are further illustrated in FIG. 12.

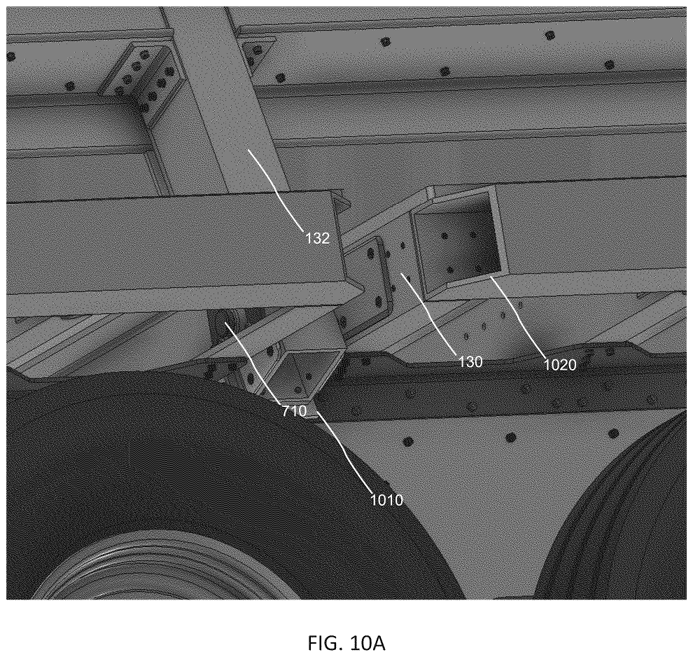

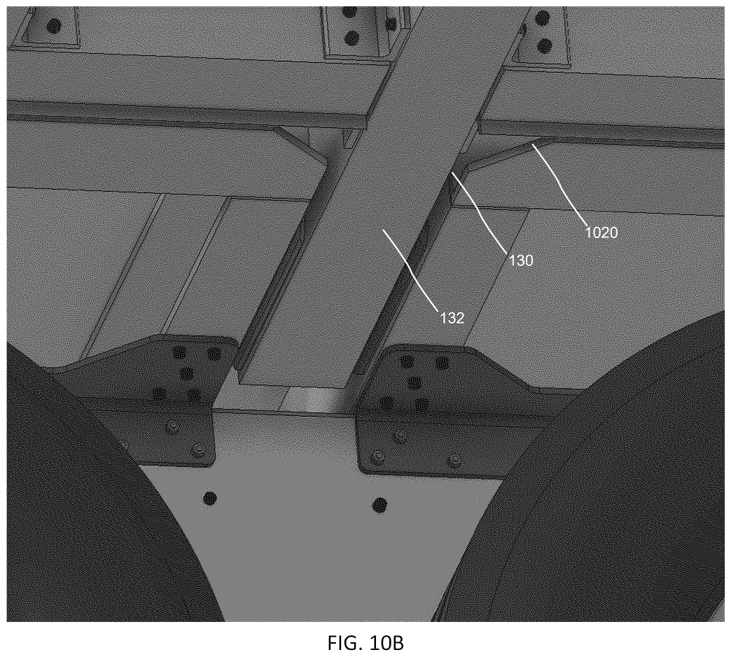

FIGS. 10A and 10B illustrate detailed views of the hinge of panels of the landing pad between folded (FIG. 10A) and deployed (FIG. 10B) positions. As shown in FIG. 10A, the support 132 rotates about the hinge axis 710 (e.g., provided by a pin), in the space provided by the hinge opening 130. The opening 130 includes chamfered or rounded corners 1020 to avoid potential interference with the support 132. The support 132 includes an open end 1010 cleared from contacting or interfering with other structures of the frame 600 (also shown in FIG. 10B).

In some embodiments, as shown in detailed views in FIGS. 11A-11C, the second panel 112 uses the locking mechanism 140 (also referred to as a stowed latch) to engage the corresponding opening 144 of the third panel 114. The opening 144 receives a hook 1110 of the locking mechanism 140 to secure the second panel 112 and the third panel 114 in the folded configuration during transportation. In the examples shown in FIGS. 11A-11C, the locking mechanism 140 includes: an actuator 1120 configured to actuate a linkage 1130, which moves the hook 1110 to engage the corresponding opening 144 of the third panel 114. The locking mechanism 140 further includes a handle or switch 1210 (as shown in FIG. 12 for details) controlling the actuator 1120. The hook 1110 may engage a rod 1140 on the opposite side of the opening 144 for a tightened engagement.

As shown in FIG. 12, the switch 1210 includes a manual lever 1230 mechanically linked to the actuator 1120. The manual lever 1230 is movable between an open position and a closed position. For example, the manual lever 1230 is lockable at the open position (by inserting a pin 1220 at a first position) and the closed position (by inserting the pin 1220 at another position). Although a manual actuation example is shown, in some embodiments, a powered actuator may be used (e.g., also controlled by the controller in the control compartment 122, which includes a corresponding power supply).

FIG. 13 illustrates a ground mobile landing assistance system including the landing pad 100 in the folded position being towed by a vehicle 1300, in accordance with aspects of the present disclosure. In the folded configuration, the landing pad 100 fits within a common traffic lane. For example, referring to the top view 200 of FIG. 2, the first panel 110 of the landing pad 100 has a width 210 that is not greater than a traffic lane width (10-12 ft, or 3.7 m).

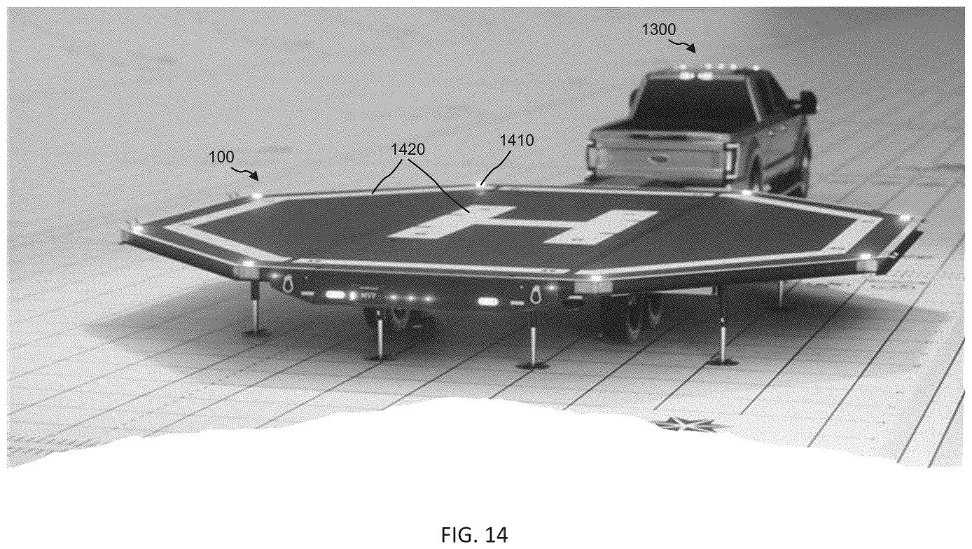

FIG. 14 illustrates the ground mobile landing assistance system of FIG. 13 in a deployment configuration. As shown, the landing pad 100 is unfolded with the stabilizers 302 extended to provide support from the ground surface. Furthermore, the first panel 110, the second panel 112, and the third panel 114 provide a plurality of light-emitting devices 1410 and reflective optical aids 1420 (e.g., informative reflective shapes or patterns) for identifying the landing pad 100.

In some embodiments, the landing pad 100 may have a system configuration including at least one of: fixed stairs, torsion beam axles and suspension, electric brakes, 6-point leveling system with outrigger pads, manually operated outrigger arms, manual trailer jack, 2- 5/16″ pull hitch ball, 4x storage boxes, 2-cell onboard battery package, 110 v shore power interface with battery charger, touchdown and liftoff (TLOF) lighting system, flight deck and ground flood lighting system, or a color scheme of black and yellow flight deck on mission smoke frame.

In some embodiments, the landing pad 100 may include at least one of the following systems: a system that collects, processes, and analyzes location based information, such as Global Positioning System (GPS), Global Navigation Satellite System (GNSS), or Real-Time Kinematic (RTK) System. The landing pad 100 may further integrate with other systems, such as, for example, a micro weather station with GPS (cellular link enabled or satellite link enabled) and a pilot activated lighting controller (PALC). The landing pad 100 may further measure or compute the weight of pad, the output of an aircraft, the platform level/slope/grade output, a system for autopilot execution; or a flight deck human machine interface (HMI). For example, the control compartment 122 includes a computational system capable of processing various onboard sensing data as well as data received via wireless connection.

In some embodiments, the landing pad 100 includes equipment for refueling and/or recharging. For example, the landing pad 100 may be equipped with (e.g., under the first panel 110 in spaces available) refueling bladders or fuel tanks for refueling combustion based ariel vehicles. Alternatively, or in addition, the landing pad 100 may be equipped with capacitors, batteries, and other power supply (e.g., internal combustion generators, solar panels, etc.). The landing pad 100 may include a wired interface or wireless charging transmitters for recharging electrical aerial vehicles.

In some embodiments, the landing pad 100 includes self-leveling stairs (e.g., the foldable staircase 150 includes actuated and adjustable supports). In some embodiments, the landing pad 100 includes ramps (e.g., retractable, detachable, or foldable). In some embodiments, the landing pad 100 includes lift systems.

In some embodiments, the landing pad 100 includes various mechanical systems for the functionalities of land transportation. For example, the landing pad 100 may include an air or spring suspension system and a hydraulic surge brake system for ground transportation. The landing pad 100 may include a leveling system for adjustment on uneven ground or a slope. In some embodiments, the landing pad 100 includes an automated or manual outrigger arm, a powered or manual trailer jack, and/or a hitch trailer lunette ring. As shown in FIGS. 4, 5 and 8, the landing pad 100 includes multiple storage boxes. The landing pad 100 may further include operation accessories or redundancies, including but not limited to spare tires, a retractable flightdeck grounding cable, traffic control beacons, and windsock.

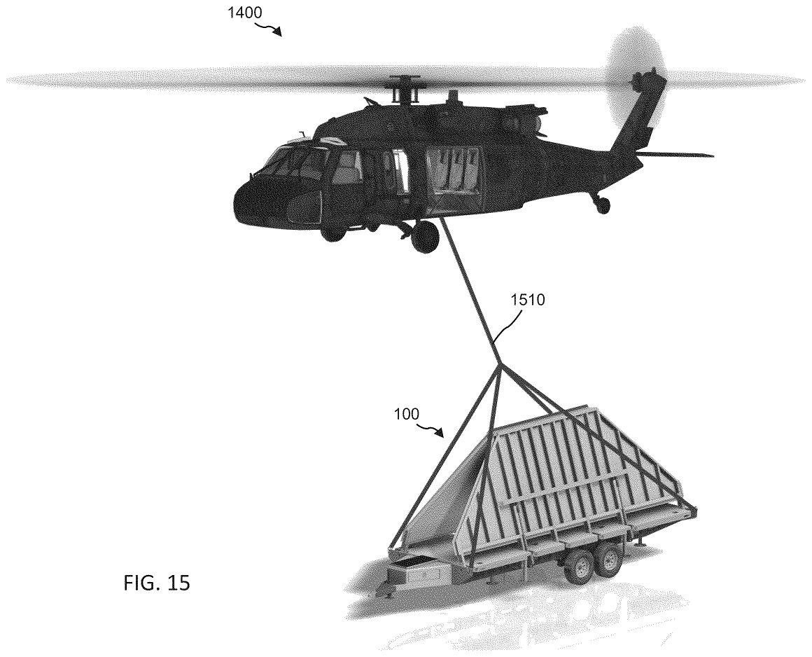

FIG. 15 illustrates an air mobile landing assistance system including the landing pad 100 in the folded position being sling lifted. As shown, a helicopter (or another aerial vehicle, such as an unmanned VTOL aircraft) 1400 is configured to lift the landing pad 100 open in air during transportation, via a cable or harness 1510. The folded configuration of the landing pad 100 reduces air resistance and improves handling by the helicopter 1400.

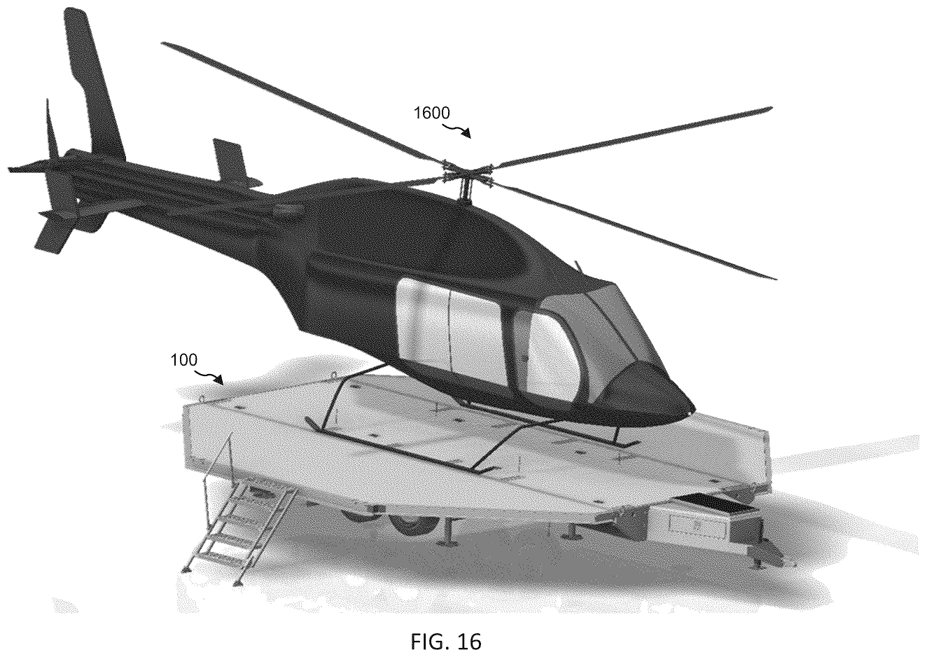

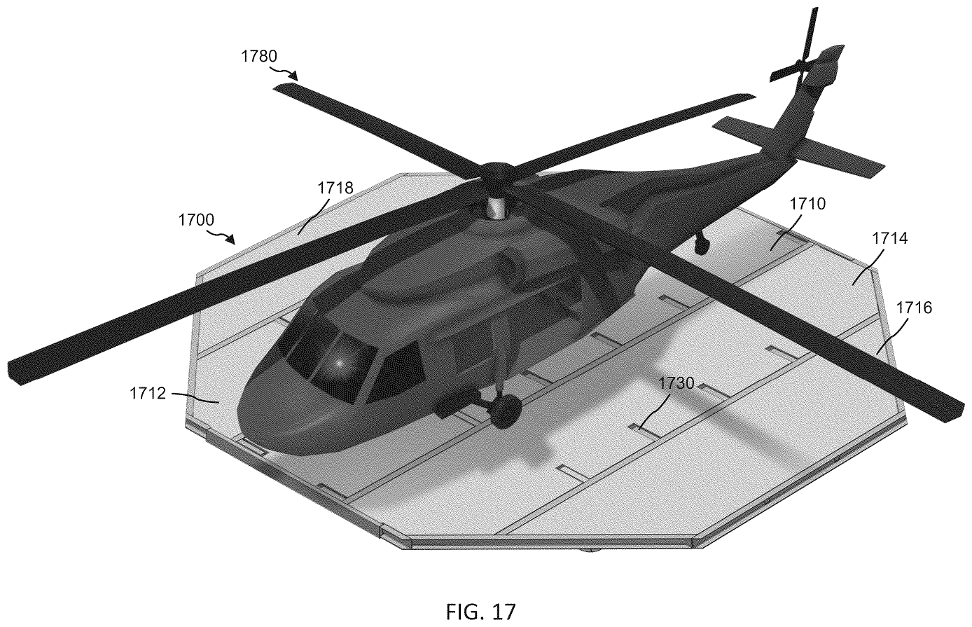

FIG. 16 illustrates an example of a small VTOL aircraft 1600 (relative to the aircraft shown in FIG. 17), in accordance with aspects of the present disclosure. As shown, the VTOL aircraft 1600 has landed on the deployed landing pad 100. The VTOL aircraft 1600's primary mass (including the engine, transmission, and main rotor mast, etc.) is centrally located beneath the main rotor system and is fully within the perimeter of the landing pad 100. As such, the landing pad 100 provides sufficient support and landing area for the VTOL aircraft 1600 (e.g., via the skids as shown) even when a portion of the VTOL aircraft 1600, such as the tail rotor, extends outside of the landing area provided by the landing pad 100.

FIG. 17 illustrates a second example foldable landing pad 1700 for use with a VTOL aircraft 1780. As shown, the VTOL aircraft 1780 is larger than the aircraft 1600 of FIG. 16. The second example of the landing pad 1700 has a greater deployment dimension than the landing pad 100. To achieve a similar width as the landing pad 100, the second example of the landing pad 1700 has additional fold lines (e.g., on each side of the center panel 1710, the side panels are further foldable between 1714 and 1716, or 1712 and 1718. As such, when a different deployment size or transportation volume is desired, additional number of folds may be implemented.

As shown in FIG. 17, the second example foldable landing pad 1700 includes, besides a first panel 1710 (like the first panel 110), a second panel 1712 (like the second panel 112), and a third panel 1714 (like the third panel 114), a fourth panel 1716 that is hinged at an outer edge of the second panel 1714. The landing pad 1700 further includes a fifth panel 1718 hinged at an outer edge of the third panel 1712. The fourth panel 1716 is foldable toward the second panel 1714 during transportation and deployable to align with the top surface 104 for use as the helipad. The fifth panel 1718 is foldable toward the third panel 1712 during transportation and deployable to align with the top surface 104 for use as the helipad.

In some embodiments, the fourth panel 1716 and the fifth panel 1718 respectively includes a lock-in mechanism 1730 that biases respective hinge connections between the fourth panel 1716 and the second panel 1712, and the fifth panel 1718, and the third panel 1712, to stay aligned with the top surface.

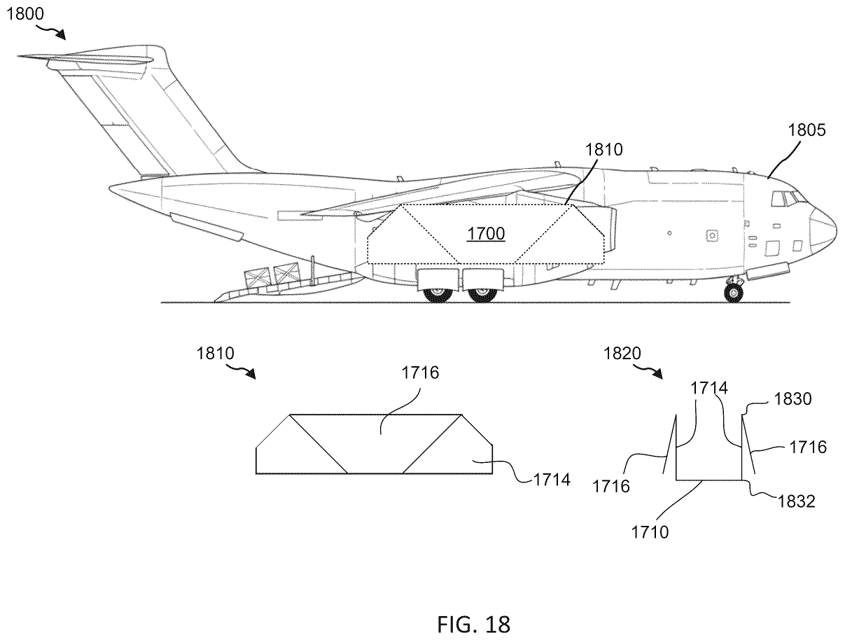

FIG. 18 illustrates the second example mobile landing assistance system 1800 of the foldable landing pad 1700 of FIG. 17 in a folded configuration, in accordance with aspects of the present disclosure. As shown, the landing pad 1700 may be fitted inside an aerial vehicle 1805 (e.g., a cargo airplane, such as the C130) configured to enclose and carry the landing pad 1700 during transportation. FIG. 18 includes a side view 1810 and a front view 1820 of the folded configuration of the landing pad 1700. As shown in the side view 1810, the folded landing pad 1700 has a height corresponding to the widths of the panels 1714 and 1716.

As shown in the front view 1820, the folded landing pad 1700 has a width corresponding to approximately the width of the first panel 1710. The panels 1714 may rotate about the hinge axis 1830, and the panels 1716 may rotate about the hinge axis 1832. Although the panels 1714 are illustrated to form an approximate right angle with the first panel 1710, the panels 1714 may further rotate toward each other and interlock using a similar locking mechanism as the locking mechanism 140. Similarly, the panels 1716 may be further rotated toward the corresponding panels 1714 and be secured using a locking mechanism. During deployment, the folded landing pad 1700 may be dropped from a specified altitude and utilize the impact with the ground to unfold and lock into the deployed configuration as shown in FIG. 17.

In some embodiments, the landing pad 100 has a 13.6 metric ton (30,000 lb). operational capacity with a safety factor of two (2). The landing pad 100 may accommodate all skid, wheeled, and pylon type landing gear that are within the 13.6 tons (30,000 lbs) maximum takeoff weight (MTOW). In addition to the physical mechanical pad structure, example integrated avionics may be available and packaged within the pad structure. The onboard electronics may include at least one of: aircraft instrumentation panels, support test equipment, high precision latitude/longitude, field elevation (WGS-84), surface wind azimuth and velocity, temperature data (pressure altitude, PA; or density altitude, DA), weight measuring (Load/Unload), data radio, solar paneling and battery system, or lighting: visible and infrared, among other electronics.

In some embodiments, some of the example avionics may be combined and integrated within a Ground Based Augmentation System (GBAS), which refers to a ground based GNSS station which provides local differential corrections, integrity parameters and approach data via very high frequency (VHF) data broadcast to GNSS users to meet real-time performance requirements for category (CAT) I precision approaches. The aircraft applies the broadcast data to improve the accuracy and integrity of its GNSS signals and computes the deviations to the selected approach. A single ground station may serve multiple runway ends, up to an approximate radius of 23 nautical miles (NM).

Ground Based Augmentation System (GBAS) Landing System (GLS)-A type of precision IAP based on local augmentation of GNSS data using a single GBAS station to transmit locally corrected GNSS data, integrity parameters and approach information. This improves the accuracy of aircraft GNSS receivers'signal in space, enabling the pilot to fly a precision approach with much greater flexibility, reliability, and complexity. The GLS procedure is published on standard IAP charts, and features the title GLS with the designated runway and minima decision altitude (DA), as low as 60 m (200 ft). Future plans are expected to support CAT II and CAT III operations.

MICRO Ground Based Augmentation System (M-GBAS) Landing System (GLS)-A type of precision IAP based on local augmentation of GNSS data using a Multiple GBAS station to transmit geographically focused GNSS data, integrity parameters and approach information in an urban air mobility environment.

A Local Area Augmentation System (LAAS) may be created for each landing pad as part of the example Avionics package. For example, the LAAS may provide high accuracy for Category I and eventually Category II & III precision approaches. The LAAS may provide navigation and precision approach service in the vicinity of the host airport (approximately 23-mile radius). One LAAS ground station may provide services to multiple runways and potentially multiple airports/landing areas. Broadcasts correction messages via a VHF radio data link from a ground-based transmitter. Final approach segment data block is stored in the ground-based database (not in the aircraft) and served to the aircraft.

The landing pad 100 is deployable and operable in all-weather climates and environments within the Industrial temperature range of −20° C. to +85° C. During deployment, no sub-grade prep required. The landing pad does not require subgrade conditioning. Once deployed, the landing pad may self/auto-level to 7% grade IAW Landing Zone/Pick-Up Zone (LZ/PZ) Diagram and Reconnaissance per FM 3-04. Regarding ground slope restrictions, the landing pad allows an aircraft to land where ground slope measures 7% grade or less when no advisory is required. When the slope exceeds 7% grade, OH & UH A/C that utilize skids for landing may terminate at a hover. When the slope measures between 7 and 15 degrees, large UH & CH A/C that utilize wheels for landing, are issued an advisory, and they may land upslope. If the slope exceeds 15 degrees, all A/C may terminate at a hover.

The landing pad 100 may conform to standard Straight-line courses as geodesic paths, in view of the following dimensional considerations: lateral and longitudinal dimensions, straight-line courses as geodesic path, parallel & trapezoidal boundary lines perpendicular to the geodesic path, etc. One may determine OEA lateral boundary relative to course centerline using ellipsoidal calculations. Additional dimensional considerations include vertical dimensions (surface elevations), clearance surfaces are either a level or sloping plane relative to a defined origin MSL elevation. One may evaluate the orthometric height above the geoid (MSL) of obstacles and terrain relative to these surfaces. For alignment, the tolerance is ±0.03 degrees of course differentials.

In some embodiments, the landing pad 100 transport is a common trailer style system which uses a standard ball interface. In addition to the standard trailer towing system, the landing pad is intended to be airlifted for fielding and deployment. Actuators operate the self-leveling outriggers and deployment mechanisms. The flight deck is packaged with recessed flight landing lights, deck, and ground flood lights to aid pilots and operators. Lighting may also be radio controlled via standard flight equipment. The landing pad 100 is toolless for a single operator to rapidly deploy.

In some embodiments, the landing surface panels 110, 112, and 114 of the landing pad 100 are fabricated from a structural high-density foam with a nonslip surface for all weather anti-slip durability. The panels 110, 112, and 114 are lightweight, abrasion and puncture resistant, engineered composite floorboards. The panels are engineered with high glass content skins optimized to provide durability and stiffness at the lowest weight possible. For example, the composite panels include fiber reinforcement saturated in a polypropylene copolymer thermoplastic resin matrix. The unbalanced skin layup provides exceptional durability on the top surface and maximum stiffness to save weight and outperform traditional flooring solutions. Relevant product specifications and literature shall detail the panel properties.

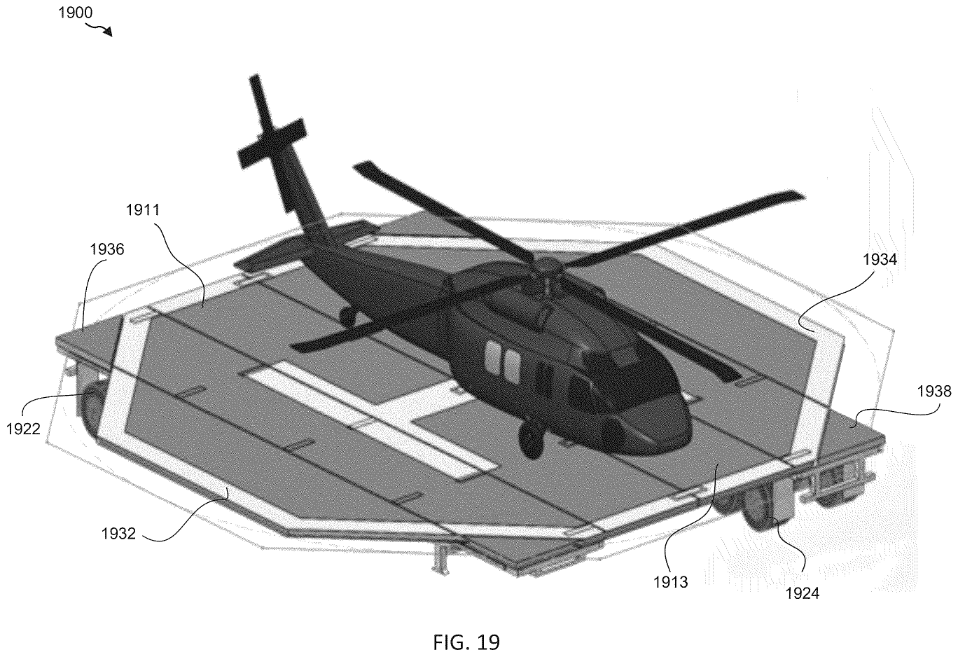

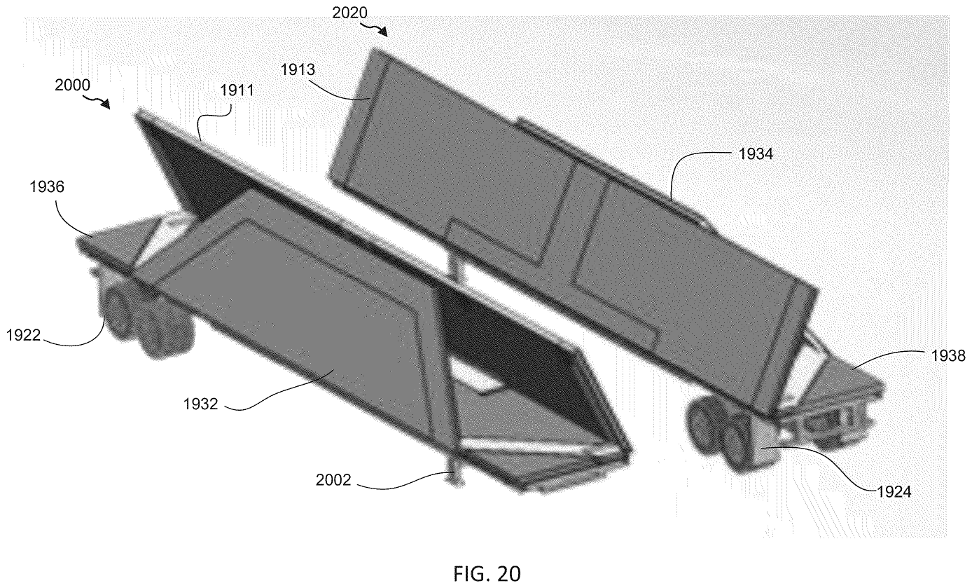

FIGS. 19 and 20 illustrate a third mobile landing assistance system 1900 in a deployed configuration, in accordance with aspects of the present disclosure. As shown, the mobile landing assistance system 1900 includes two trailer-transportable landing pads 1922 and 1924 assembled to form a greater landing area than that of the landing pad 100. Each of the landing pads 1922 and 1924 include three panels that fold during transportation. The landing pad 1922 includes a first panel 1936 a second panel 1911, and a third panel 1932. The second panel 1911 and the third panel 1932 are foldable toward each other into a folded configuration 2000 as shown in FIG. 20. Similarly, the landing pad 1924 includes a first panel 1938, a second panel 1913, and a third panel 1934. The second panel 1913 and the third panel 1934 are foldable toward each other into a folded configuration 2020 as shown in FIG. 20.

In some embodiments, the landing pads 1922 and 1924 are similar to the landing pad 100 regarding various onboard systems. The landing pads 1922 and 1924 allow for a larger landing area by using, for example, two tessellated trailers, achieving about 18.3 m (60 ft) octagonal landing surface. When in the transportation folded configuration, the landing pads 1922 and 1924 have a length for about 16.2 m (53 ft), and a height under 4.3 m (14 ft). The fully deployed and assembled system, as supported by multiple stabilizers 2002, has a 147 thousand pounds maximum operational capacity, which handles various large aircrafts, such as the CH-53E Super Stallion, CH-47 Chinook, and others. The landing pads 1922 and 1924 also have onboard auto leveling system that handles unprepared surfaces for up to 10% grade slope. Similar to the landing pad 100, the landing pads 1922 and 1924 may include visual landing surface lighting with optional pilot activated lighting controller (PALC).

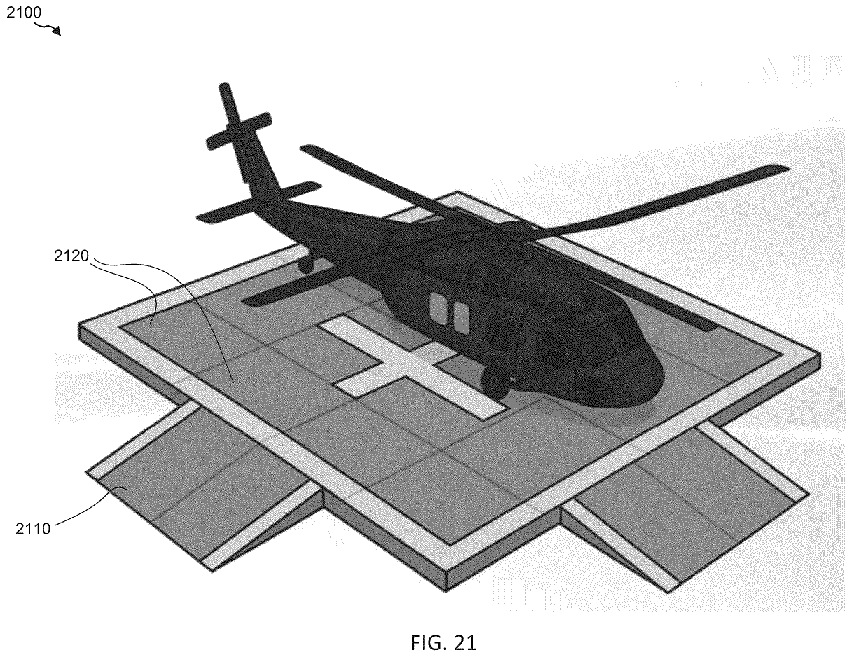

FIGS. 21 to 25 illustrate a fourth mobile landing assistance system 2100 in a deployed and assembled configuration, from general perspective views to local detailed views. FIG. 21 illustrates a general perspective view of an assembled and deployed landing assistance system 2100 (referred to as “flat deck” 2100). The flat deck 2100 includes multiple landing surface panels 2120 and access panels 2110 (e.g., ramp or stairs). The landing surface panels 2120 are stackable during storage or transportation, and are assembled using forklifts or other tools (e.g., robotic arms) for deployment. Although FIG. 21 illustrates a four by four matrix of the landing surface panels 2120, actual numbers may vary (e.g., five by five) depending on the desired landing area size.

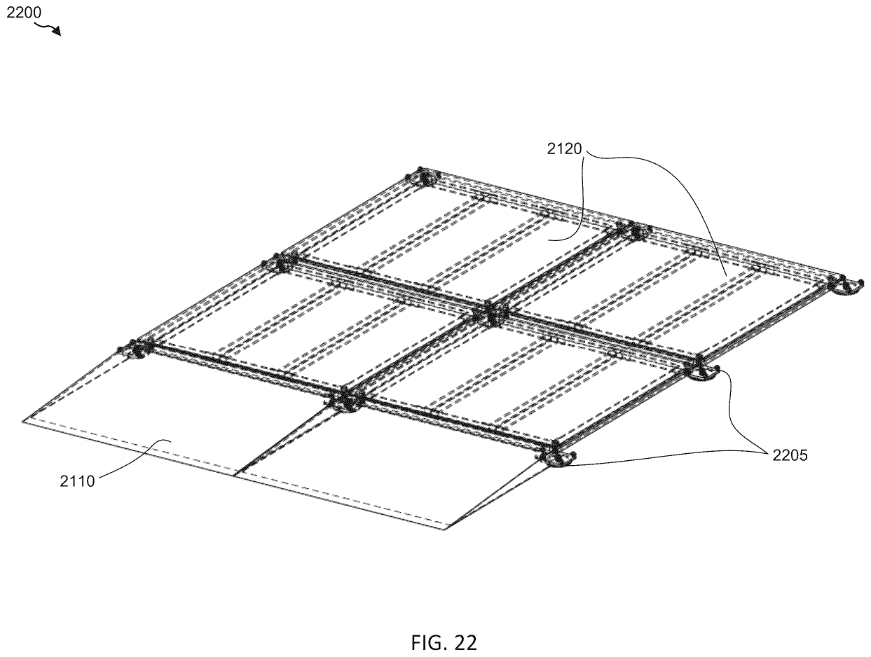

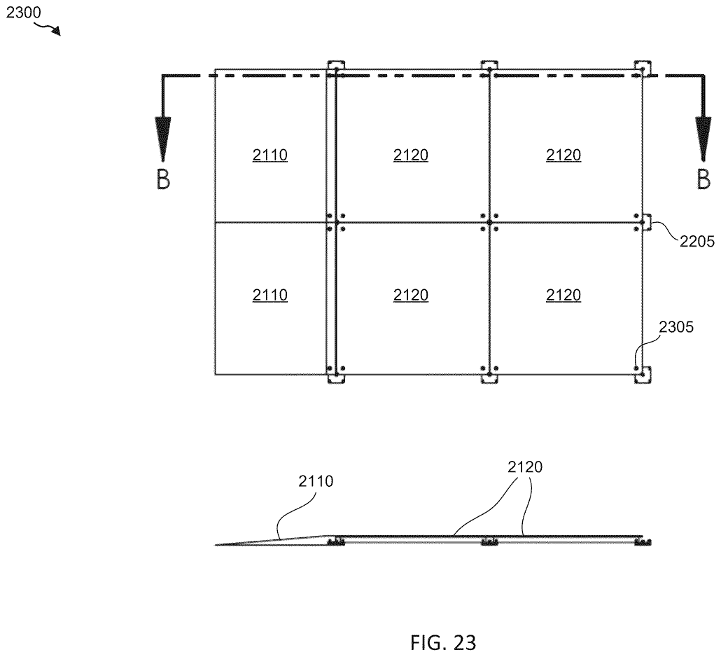

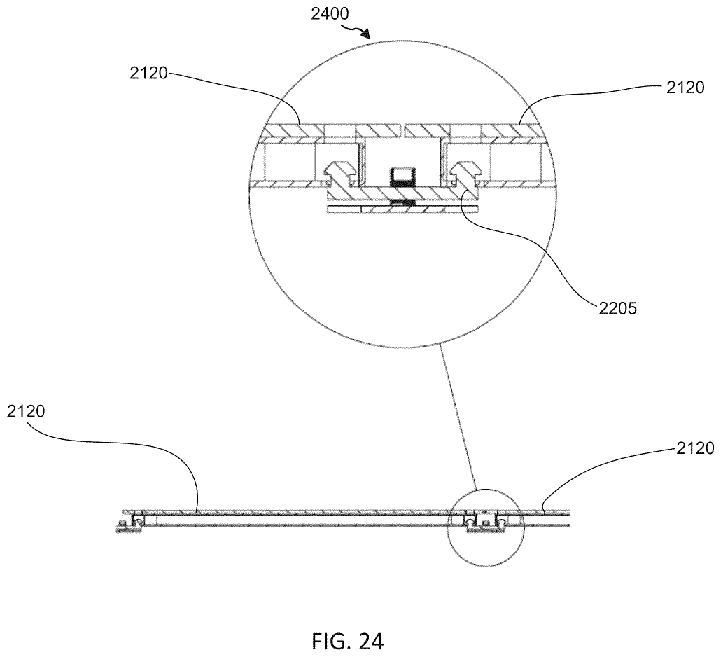

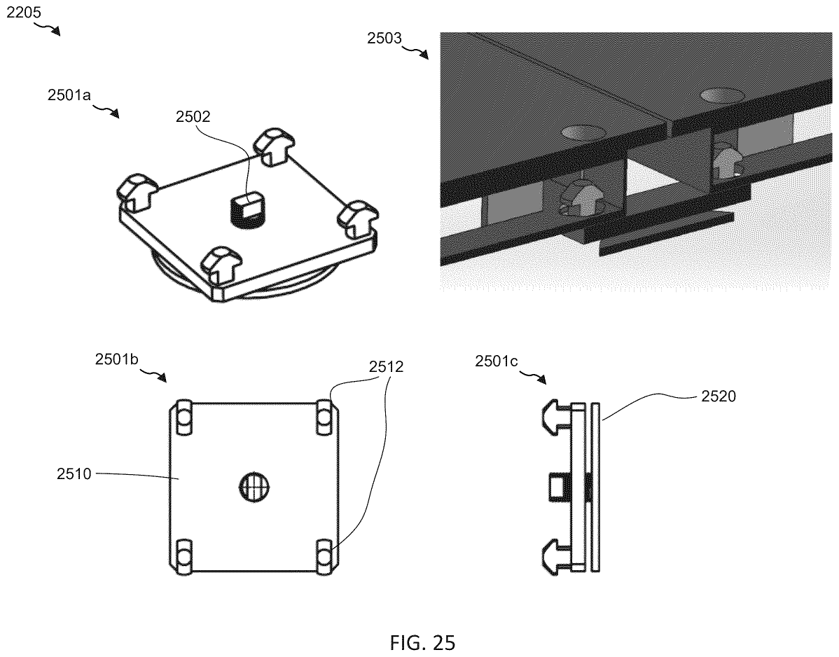

FIG. 22 illustrates a local perspective and transparent view 2200 of the flat deck 2100, in accordance with aspects of the present disclosure. As shown, the landing surface panels 2120 are connected to each other and to the access panels 2110 via connectors 2205. Details of the connectors 2205 are further illustrated in FIGS. 24 and 25. FIG. 23 illustrates a partial top view 2300 and partial cross-section side view B-B of the flat deck 2100. As shown in the cross-section side view, the landing surface panels 2120 are raised and supported by the connectors 2205, and the access panels 2110 may bridge the height differences between the surrounding ground and the raised landing surface panels 2120.

FIG. 24 illustrates a detailed local view 2400 of the partial cross-section side view of the flat deck 2100. FIG. 25 illustrates multiple different views of the connector 2205 of the flat deck 2100, including a perspective view 2501a, a top view 2501b, a side view 2501c, and a local cross-sectional perspective view 2503. As shown, the connector 2205 includes four protrusions 2512 extending from a body plate 2510. Each protrusion 2512 is shaped as an arrow in the side view and as a rectangle in the top view. The protrusions 2512 are inserted into corresponding rectangular openings 2305 in the landing surface panels 2120 and the access panels 2110. The arrow-shaped side profile of the protrusions 2512 provides ease of insertion while limiting side movements and for interlocking once fully inserted (e.g., the panels must be fully aligned to be removed from the connector 2205).

The connector 2205 further includes an extension plate 2502, which includes a rectangular head, a threaded body, and a contact foot 2520. The threaded body engages with a threaded hole in the body plate 2510. During operation, a power tool may engage the rectangular head of the extension plate 2502 to extend or retract the contact foot by rotating the threaded body. As such, the connector 2205 can be adjusted on uneven surfaces to raise the landing surface panels to form an even surface of the same height.

In some embodiments, the flat deck 2100 includes tessellated panel tiles of the size of 2.3 m by 6 m (7.5 ft by 20 ft). When deployed, the flat deck 2100 provides a landing surface of an area of about 30 m by 30 m (100 ft by 100 ft). The multi-panel assembly configuration allows for flexible reconfiguration or assembly of the flat deck 2100 into smaller (e.g., 3 by 3 panels) or larger (e.g., 6 by 6 panels) landing platforms. Each panel may include various functional systems similar to those of the landing pad 100.

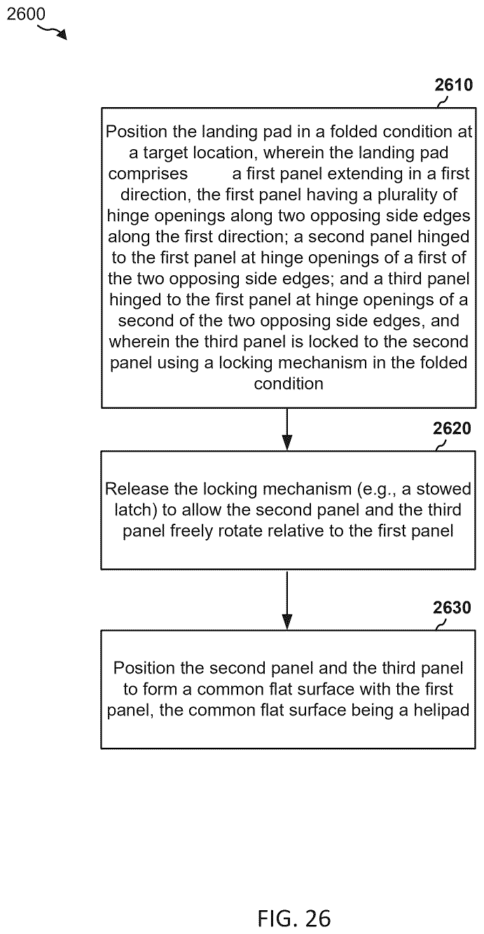

FIG. 26 illustrates a flow chart of the process of deploying a landing pad, in accordance with aspects of the present disclosure. As shown, at 2610, the landing pad in a folded condition is positioned at a target location. The landing pad includes a first panel extending in a first direction, the first panel having a plurality of hinge openings along two opposing side edges along the first direction; a second panel hinged to the first panel at hinge openings of a first of the two opposing side edges; and a third panel hinged to the first panel at hinge openings of a second of the two opposing side edges, and wherein the third panel is locked to the second panel using a locking mechanism in the folded condition.

At 2620, the locking mechanism is released to allow the second panel and the third panel freely rotate relative to the first panel.

At 2630, the second panel and the third panel are positioned to form a common flat surface with the first panel, the common flat surface being a helipad.

In addition, the landing pad further includes: a plurality of rollers or wheels mounted to and rotatable under the first panel; a plurality of trailer stabilizers; a trailer tongue coupler at a front end of the first panel; and a trailer tongue jack.

In some embodiments, the plurality of trailer stabilizers is distributed under the first panel, the second panel, and the third panel, and the plurality of trailer stabilizers, when deployed, levels the landing pad on a slope.

In some embodiments, wherein the second panel and the third panel respectively include: a foldable staircase; a plurality of storage units underneath the first panel; and one or more hydraulic cylinders hinged on the first panel and configured to respectively power the second panel and the third panel to move between a folded position and a deployed position.

In some embodiments, the second panel includes a locking mechanism, and the third panel includes a corresponding opening to receive a hook of the locking mechanism to secure the second panel and the third panel in a folded position.

In some embodiments, the locking mechanism further includes: an actuator configured to actuate a linkage causing a hook to engage the corresponding opening of the third panel; and a switch controlling the actuator.

In some embodiments, the switch includes a manual lever mechanically linked to the actuator, wherein the manual lever is movable between an open position and a closed position, and wherein the manual lever is lockable at the open position and the closed position.

In some embodiments, the landing pad further includes: a fourth panel hinged at an outer edge of the second panel; and a fifth panel hinged at an outer edge of the third panel. The fourth panel is foldable toward the second panel during transportation and deployable to align with the top surface for use as the helipad. The fifth panel is foldable toward the third panel during transportation and deployable to align with the top surface for use as the helipad. The fourth panel and the fifth panel respectively include a lock-in mechanism that biases respective hinge connections between the fourth panel and the second panel, and the fifth panel and the third panel, to stay aligned with the top surface.

Various aforementioned limitations and features, such as the different embodiments for the landing pad 100, provide common features also applicable to other examples, such as the landing pads 1700, 1900, and the flat deck 2100. An ordinarily skilled artisan understands the aforementioned features of any one example may be modified or adapted to other examples for different use scenarios as well as different configurations (e.g., of different sizes and transportation means).

The preceding description sets forth numerous specific details such as examples of specific systems, components, methods, and so forth, in order to provide a good understanding of several embodiments of the present disclosure. It may be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Additionally, some embodiments may be practiced in distributed computing environments where the machine-readable medium is stored on and or executed by more than one computer system. In addition, the information transferred between computer systems may either be pulled or pushed across the communication medium connecting the computer systems.

Embodiments of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent or alternating manner.

The above description of illustrated implementations of the disclosure, including what is described in the Abstract, is not intended to be exhaustive or to limit the embodiments to the precise forms disclosed. While specific implementations of, and examples for, the embodiments are described herein for illustrative purposes, various equivalent modifications are possible within the scope of the embodiments, as those skilled in the relevant art may recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

It may be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims. The claims may encompass embodiments in hardware, software, or a combination thereof.

What is claimed is:

1. A landing pad comprising:
a first panel extending in a first direction, the first panel having a plurality of hinge openings along two opposing side edges along the first direction;
a second panel hinged to the first panel at hinge openings of a first of the two opposing side edges; and
a third panel hinged to the first panel at hinge openings of a second of the two opposing side edges, the second panel and the third panel foldable toward each other during transportation and deployable to provide a flat top surface together with the first panel during use as a helipad.

2. The landing pad of claim 1, further comprising:
a plurality of rollers or wheels mounted to and rotatable under the first panel;
a plurality of trailer stabilizers;
a trailer tongue coupler at a front end of the first panel; and
a trailer tongue jack.

3. The landing pad of claim 2, wherein the plurality of trailer stabilizers is distributed under the first panel, the second panel, and the third panel, and the plurality of trailer stabilizers, when deployed, levels the landing pad on a slope.

4. The landing pad of claim 1, wherein the second panel and the third panel respectively comprise:
a foldable staircase, ramp or lift;
a plurality of storage units underneath the first panel; and
one or more hydraulic cylinders hinged on the first panel and configured to respectively power the second panel and the third panel to move between a folded position and a deployed position.

5. The landing pad of claim 1, wherein the second panel comprises a locking mechanism and the third panel comprises a corresponding opening to receive a hook of the locking mechanism to secure the second panel and the third panel in a folded position.

6. The landing pad of claim 5, wherein the locking mechanism further comprises:
an actuator configured to actuate a linkage causing the hook to engage the corresponding opening of the third panel; and
a switch controlling the actuator.

7. The landing pad of claim 6, wherein the switch comprises a manual lever mechanically linked to the actuator, wherein the manual lever is movable between an open position and a closed position, and wherein the manual lever is lockable at the open position and the closed position.

8. The landing pad of claim 1, wherein the first panel has a width no greater than a traffic lane width, and wherein the first panel, the second panel, and the third panel provide a plurality of light-emitting and optical aids for identifying the landing pad.

9. The landing pad of claim 1, further comprising:
a fourth panel hinged at an outer edge of the second panel; and
a fifth panel hinged at an outer edge of the third panel, wherein the fourth panel is foldable toward the second panel during transportation and deployable to align with the top surface for use as the helipad, and wherein the fifth panel is foldable toward the third panel during transportation and deployable to align with the top surface for use as the helipad.

10. The landing pad of claim 9, wherein the fourth panel and the fifth panel respectively comprise a lock-in mechanism that biases respective hinge connections between the fourth panel and the second panel, and the fifth panel and the third panel, to stay aligned with the top surface.

11. A mobile landing assistance system comprising:
a vehicle providing mobility; and
a landing pad securable to the vehicle for transportation, the landing pad comprising:
a first panel extending in a first direction, the first panel having a plurality of hinge openings along two opposing side edges along the first direction;
a second panel hinged to the first panel at hinge openings of a first of the two opposing side edges; and
a third panel hinged to the first panel at hinge openings of a second of the two opposing side edges, the second panel and the third panel foldable toward each other during transportation and deployable to provide a flat top surface together with the first panel during use as a helipad.

12. The mobile landing assistance system of claim 11, wherein the landing pad further comprises:
a plurality of rollers or wheels mounted to and rotatable under the first panel;
a plurality of trailer stabilizers;
a trailer tongue coupler at a front end of the first panel; and
a trailer tongue jack.

13. The mobile landing assistance system of claim 12, wherein the plurality of trailer stabilizers is distributed under the first panel, the second panel, and the third panel, and the plurality of trailer stabilizers, when deployed, levels the landing pad on a slope.

14. The mobile landing assistance system of claim 11, wherein the second panel and the third panel respectively comprise:
a foldable staircase, ramp or lift;
a plurality of storage units underneath the first panel; and
one or more hydraulic cylinders hinged on the first panel and configured to respectively power the second panel and the third panel to move between a folded position and a deployed position.

15. The mobile landing assistance system of claim 11, wherein the second panel comprises a locking mechanism and the third panel comprises a corresponding opening to receive a hook of the locking mechanism to secure the second panel and the third panel in a folded position.

16. The mobile landing assistance system of claim 15, wherein the locking mechanism further comprises:
an actuator configured to actuate a linkage causing the hook to engage the corresponding opening of the third panel; and
a switch controlling the actuator.

17. The mobile landing assistance system of claim 16, wherein the switch comprises a manual lever mechanically linked to the actuator, wherein the manual lever is movable between an open position and a closed position, and wherein the manual lever is lockable at the open position and the closed position.

18. The mobile landing assistance system of claim 11, wherein the landing pad further includes:
a fourth panel hinged at an outer edge of the second panel; and
a fifth panel hinged at an outer edge of the third panel, wherein the fourth panel is foldable toward the second panel during transportation and deployable to align with the top surface for use as the helipad, and wherein the fifth panel is foldable toward the third panel during transportation and deployable to align with the top surface for use as the helipad, wherein the fourth panel and the fifth panel respectively comprises a lock-in mechanism that biases respective hinge connections between the fourth panel and the second panel, and the fifth panel and the third panel, to stay aligned with the top surface.

19. The mobile landing assistance system of claim 11, wherein the vehicle comprises at least one of:
a land vehicle configured to tow the landing pad during transportation;
an ariel vehicle configured to lift the landing pad open in air during transportation; or
an ariel vehicle configured to enclose and carry the landing pad during transportation.

20. A method of transporting and deploying a landing pad, the method comprising:
positioning the landing pad in a folded condition at a target location, wherein the landing pad comprises a first panel extending in a first direction, the first panel having a plurality of hinge openings along two opposing side edges along the first direction; a second panel hinged to the first panel at hinge openings of a first of the two opposing side edges; and a third panel hinged to the first panel at hinge openings of a second of the two opposing side edges, and wherein the third panel is locked to the second panel using a locking mechanism in the folded condition;
releasing the locking mechanism to allow the second panel and the third panel freely rotate relative to the first panel; and
positioning the second panel and the third panel to form a common flat surface with the first panel, the common flat surface being a helipad.
